(19) United States
(12) Patent Application Publication
(10) Pub. No.: US 2002/0056666 A1
(43) Pub. Date: May 16, 2002

(54) Magnet structures for treating liquids and gases

(76) Inventor: Justin Sharaf, Philadelphia, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/010,159

(22) Filed: Nov. 13, 2001

Related U.S. Application Data
(63) Continuation of application No. 09/420,733, filed on Oct. 20, 1999.

(51) Int. Cl. B03C 1/00

(52) U.S. Cl. 209/214; 209/232; 95/28; 96/1

(57) ABSTRACT

The present invention relates to a system and method for the treatment of pipes, pipe systems and related equipment, and the fluid and gas carried in the pipes to prevent scaling and build-up of deposits in the pipe. A first exemplary embodiment of the system comprises a pipe for carrying a fluid and at least one magnet assembly abutting portions of the exterior of the pipe to be treated. The magnet assembly preferably includes a plurality of magnet structures, the magnet structures being disposed at different radial positions around the exterior of the pipe. Each of the magnet structures includes a housing having first and second parallel sidewalls and a top wall connecting the pair of sidewalls; at least one first magnet disposed parallel to the top wall, and so that its north pole abuts the first sidewall; at least one second magnet disposed perpendicular to the top wall, and so that its south pole abuts a south pole of the at least one first magnet; at least one third magnet disposed parallel to the top wall, and so that its south pole abuts the south pole of the at least one second magnet; at least one fourth magnet disposed perpendicular to the top wall, and so that its north pole abuts a north pole of the at least one third magnet; and, at least one fifth magnet disposed parallel to the top wall, and so that its south pole abuts the second sidewall.

### FIELD OF THE INVENTION

The present invention relates to a system and method for the separation of dissolved solids and purification of liquids and gases which are carried in pipes, and in particular, to the purification of such liquids and gases by using a magnetic assembly.

### DESCRIPTION OF THE RELATED ART

Ground and surface water supplies typically contain dissolved solids, such as calcium carbonate, which are leached from the ground, air, or from pipes carrying the water and are carried along with the water. Over time, these dissolved solids are deposited on the interior of the pipes and lead to buildup in the form of scale (e.g., calcite) within the pipes. Eventually, this buildup results in a constriction and corrosion of the pipes, and a reduction in the flow of water through the pipes. Similar materials also deposit on cooling towers, heat exchangers, boilers and other equipment which carries fluids such as water, reducing their efficiency, which in turn results in increased operation costs. Material such as iron dissolved in water can be deposited on fountains or other surfaces that are constantly in contact with water, resulting in unsightly stains. In addition, water pools, lakes, fountains, and spas often contain microorganisms, which breed algae and effect the quality of the water.

Currently, removal of scale and microorganisms is achieved by treatment with chemicals, such as hexavalent chromium, hydrochloric acid, and sodium hypochlorite. Treatment with such chemicals results in a considerable cost for the continued use of the chemicals themselves and the constant monitoring which is required to ensure that the chemicals are at the correct “working” concentrations. The use of such chemicals may lead to increased rates of corrosion of the pipes and of other structures which are subjected to them. In addition, while treatment of scale on pipes with chemicals may lead to an increased water flow by enlarging the effective internal diameter of the pipes, the scale is not removed completely, and significant amounts of scale remain in the pipes. An additional cost of the use of chemicals is to the environment. Chemicals that are used in treating the water cause contamination of the water, and such water may require collection (for additional treatment) and dumping after use. Such dumping results in a significant economic, as well as environmental, costs (e.g. to water supplies, sea life, plants and humans). Additionally, evaporated water containing chemicals releases those chemicals into the air which fall back as acid rain.

Another source of environmental pollution is the inefficient burning of gasoline in internal combustion engines, where unburned gasoline is exhausted into the environment. Also, inefficient burning of gasoline in an internal combustion engine results in a buildup on spark plugs, which necessitates frequent tune-up of engines in order to maintain their operation at a reasonable level of efficiency.

Over the last fifty years, non-ionizing irradiation processes, such as magnetic fields, have been advertised as a kind of panacea for water treatment. It has been claimed that these devices require no technical training or control and will treat water non-chemically to control microorganism growth, prevent scale, and inhibit corrosion. Variable effectiveness and little scientific understanding of the process mechanisms have produced substantial skepticism.

U.S. Pat. No. 5,238,558 to Curtis shows a system which utilizes magnetic fields for pipe treatment. The system 10 is shown in FIG. 1 of the patent, it includes a plurality (e.g. six) of magnet units 12 disposed at different radial positions around the periphery of a pipe 14. The particular structure of the magnet units 12 is shown in FIGS. 2 and 3 of the patent. Each magnet unit 12 includes a pair of end pole pieces 22 and a top pole piece 20. Sandwiched between the pole pieces 22, 20 are permanent magnets 18, 19 and 27. The magnets 18 are arranged so that their poles are parallel to the pole pieces 22 and so that they are alternating in polarity (i.e. the left magnet 18 has its north pole facing up and the right magnet 18 has its south pole facing up). The magnets 19 are arranged so that their poles are perpendicular to the pole pieces 22. Both north poles of the magnets 19 are facing towards the right. The magnets 27 have the same orientation and polarity as the magnets 18. The system 10 operates by creating a magnetic flux in the pipe 14 which suspends charged particles (i.e. impurities) traveling through the pipe. The charged particles are then removed from the pipe 14 by a separate drainage system (not shown). The particles are suspended by creating a magnetic flux in the pipe 14 which has a greater magnetic charge than the particles themselves.

FIG. 1 shows an example of the type of magnetic flux 50, 50′ created by the magnet units 12 of the system 10 described above. The magnetic flux 50, 50′ is arc-shaped, and extends between a “north” and “south” pole of each magnet unit 12. As can be seen, the field 50, 50′ created by magnets 12 of system 10 has a large circumference and extends only partially into the interior of the pipe 14. Thus, many particles (e.g. particle X in FIG. 1) which pass through the pipe 14 are not affected by the field 50, and consequently, the above-described system 10 will not completely treat and clean pipes to which it is attached.

In view of the above, there is a need for a improved system which will prevent and remove scale buildup, and inhibit the growth of microorganisms. Additionally, there is a need for a system which will aid in the complete combustion of gasoline in an internal combustion engine.

### SUMMARY OF THE INVENTION

The present invention is a magnet apparatus including a housing with at least two sidewalls, and top and bottom walls connecting the sidewalls; at least two first magnets disposed orthogonal to and abutting the bottom wall of the housing; and at least three second magnets disposed parallel to and abutting the bottom wall of the housing, one of the at least three second magnets being disposed between the at least two first magnets.

The above and other advantages and features of the present invention will be better understood from the following detailed description of the preferred embodiments of the invention which is provided in connection with the accompanying drawings.

### BRIEF DESCRIPTION OF THE DRAWINGS

FIG. 1 is a side cross section view showing a conventional magnetic treatment system.

FIG. 2 is a side cross section view of a magnet apparatus according to a first exemplary embodiment of the present invention.

FIG. 3 is a side cross section view showing a magnetic treatment system according to the first exemplary embodiment of the present invention.

FIG. 4 is a front elevation view of the magnetic treatment system shown in FIG. 3.

FIG. 5 is a side cross section view showing a magnetic treatment system according to a second exemplary embodiment of the present invention.

FIG. 6 is a front elevation view of the magnetic treatment system shown in FIG. 5.

### DETAILED DESCRIPTION

The present invention relates to a non-invasive system and method for the non-chemical separation of magnetically susceptible dissolved solids in any fluid or gas. It also enhances the removal of built-up contaminants that occur in pipe lines and equipment that carries fluids and gases. As such, the present invention assists in the non-chemical conditioning, treatment and purification of fluids and gases, and the associated transmission systems (e.g. pipes).

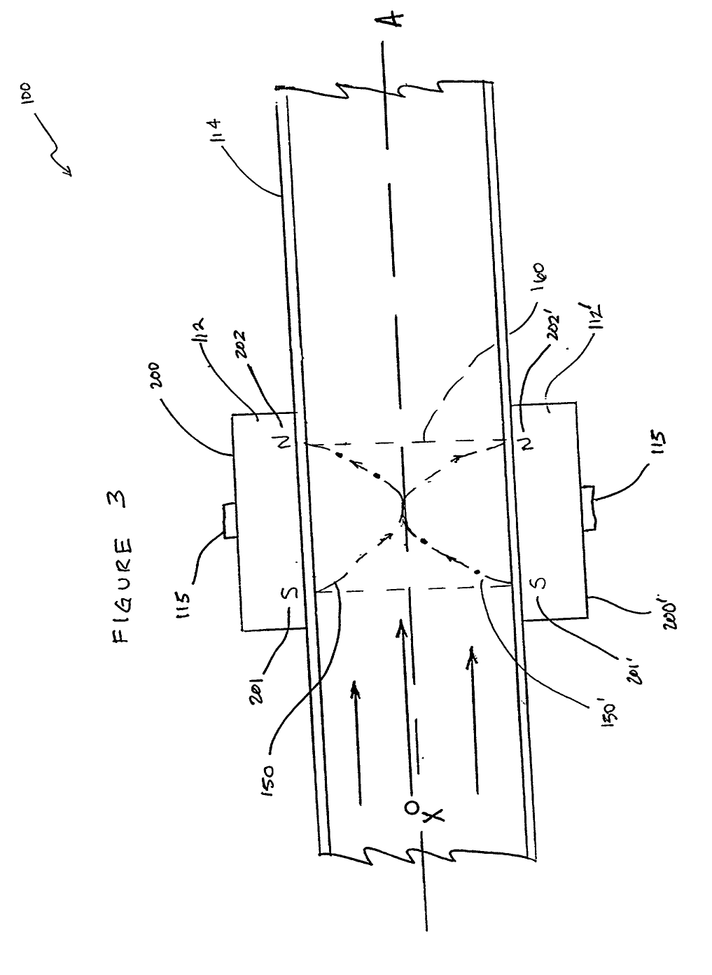

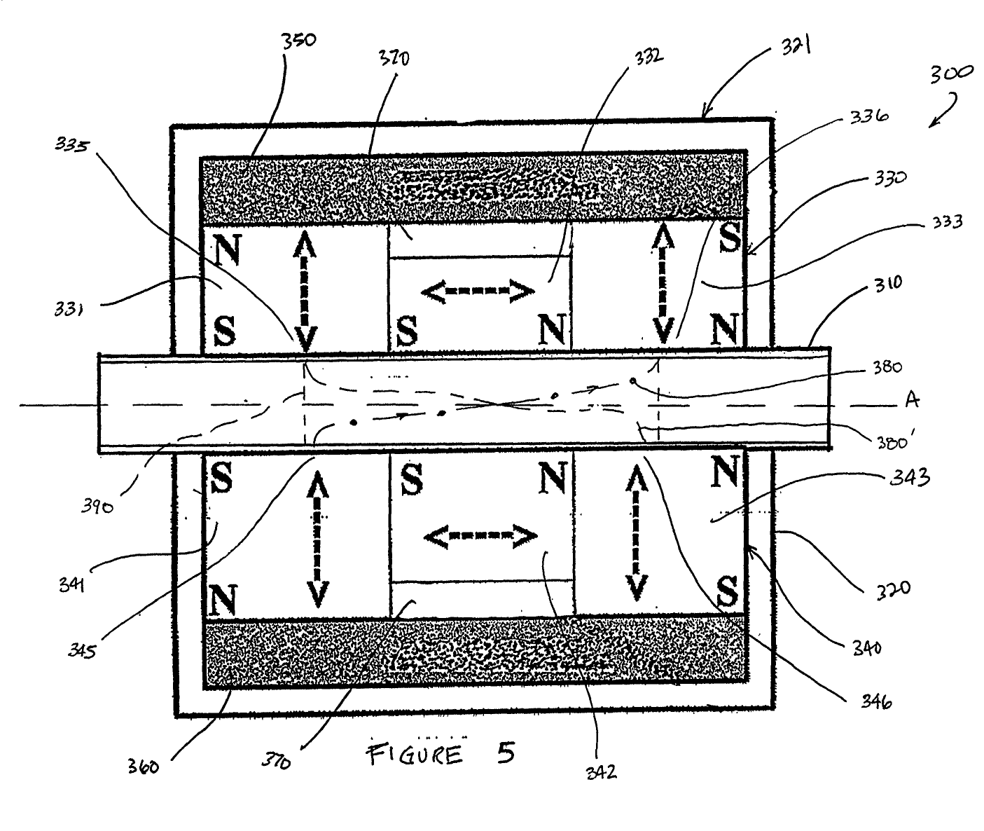

The present invention is made to satisfy Faraday's Laws of Motion which state that whenever an electrically charged particle in a fluid or gas comes across a stronger magnetic flux, it polarizes. Thus, the present invention creates a magnetic flux which is stronger than the electrical charge on particles dissolved in the fluid or gas. The present invention is also disposed such that the fluid or gas flows across the magnetic flux at approximately a ninety (90) degree angle. By causing a polarization of the electrically charged particles present in the fluid or gas, the present invention causes the particles to go from a dissolved state to a suspended state. When the particles are in a suspended state, they are physically disposed in the fluid or gas, but are not part of the fluid or gas, much as a spoon placed in a glass of water, and thus may be easily removed. In order to create such a magnetic flux, the present invention utilizes a series of magnet apparatus (explained below), which surround a pipe carrying the fluid or gas. The magnet apparatus are arranged so that their respective “north” and “south” poles repel each other across the pipe. Thus, the “south” pole of one magnet apparatus will be prevented from seeking the “north” pole of the same magnet apparatus. Instead, the “south” pole of one magnet apparatus seeks the “north” pole of a magnet apparatus disposed on an opposing side of the pipe (see FIGS. 3 and 5). Therefore, a magnetic flux or fluxes are created which reach across the entire pipe, and consequently charged particles which are present in the fluid or gas flowing in the pipe must pass through the magnetic flux. As the charged particles encounter the stronger magnetic flux, they go into a suspended state, and can thus be easily removed from the fluid or gas, thereby purifying the fluid or gas.

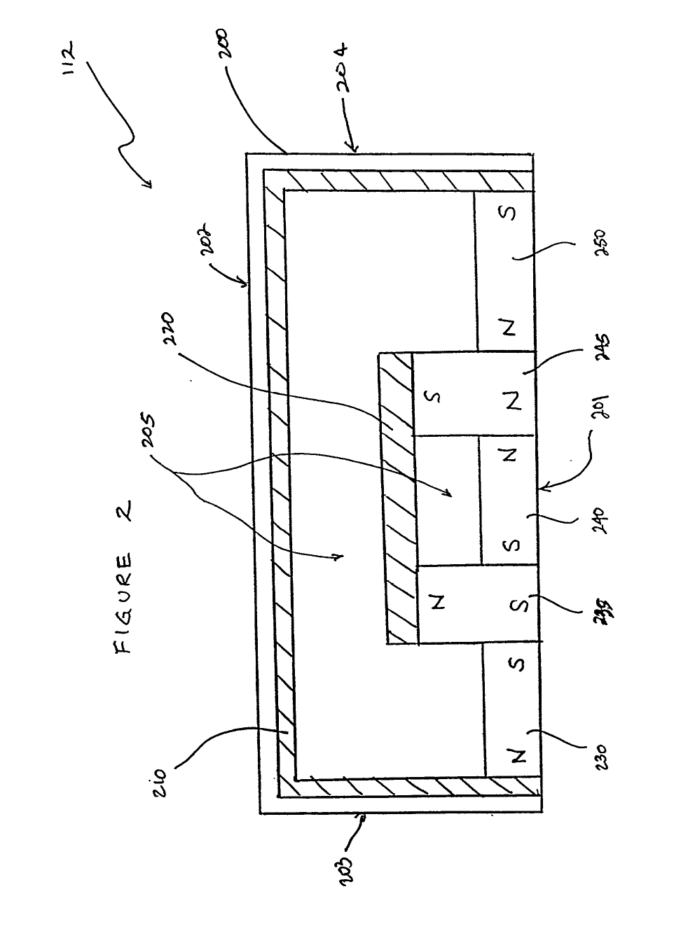

Referring to FIG. 2, there is shown a magnet apparatus 112 according to a first 2 0 exemplary embodiment of the present invention. The magnet apparatus 112 is comprised of a housing 200 made of plastic or similar material with a bottom wall 201, a top wall 202, and first 203 and second 204 sidewalls. The bottom wall 201 of the housing 200 preferably abuts a pipe (not shown) when the magnet apparatus 112 is attached thereto. Inside the housing 200 there is disposed a first pole structure 210 for directing the magnetic field of the magnetic apparatus 112. The housing 200 also includes a second pole structure 220, also for directing the magnetic field of the magnetic apparatus 112. Preferably, the pole structures 210, 220 are made of ferromagnetic metals, however they may be made of any ferromagnetic material. Although the first pole structure 210 is shown as being formed of a unitary U-shaped member, it should be noted by those skilled in the art that the structure may also be formed by separate pieces without departing from the scope of the invention.

The magnet apparatus 112 also includes a plurality of magnets 230-250 disposed within the housing 200. Preferably, the plurality of magnets 230-250 comprise permanent magnets, however, they may alternatively comprise electromagnets. The magnets 230-250 may be made of a rare earth trivalent element such as Neodymium (Nd) mixed with Boron (B) and Iron (Fe). Preferably, the magnets 230-250 are made using Neodymium 44 (Neodymium with a heat-flux ratio of 44), however, they may also be made using Neodymium 17, 19, 25, 29, 35 or Neodymium with any other suitable heat-flux ratio. Additionally, the magnets 230-250 are preferably coated with a double nickel plating layer, however, they may be coated with any type of suitable layer known to those skilled in the art.

A first magnet 230 is disposed so that its poles are parallel to the bottom wall 201 of the housing 200, and so that its “north” pole abuts the first pole structure 210. A “south” pole of the second magnet 230 abuts a “south” pole of a second magnet 235. The second magnet 235 is disposed so that its poles are orthogonal to the bottom wall 201 of the housing 200, and so that its “north” pole abuts the second pole structure 220. A third magnet 240, also disposed with its poles parallel to the bottom wall 201 of the housing 200, is disposed so that a “south” pole thereof abuts the “south”, pole of the second magnet 235. A “north” pole of the third magnet 240 abuts a “north” pole of a fourth magnet 245. The fourth magnet 245 is disposed with its poles orthogonal to the bottom wall 201 of the housing, and so that its “south” pole abuts the second pole structure 220. A fifth magnet 250 is disposed with its poles parallel to the bottom wall 201 of the housing 200, and so that its “south” pole abuts the first pole structure 210. The “north” pole of the fifth magnet 250 abuts the “north” pole of the fourth magnet 245. Areas 205 of the housing 200 which do not include either pole structures or magnets may be filled with a non-magnetic (e.g. plastic) material, or may be left open.

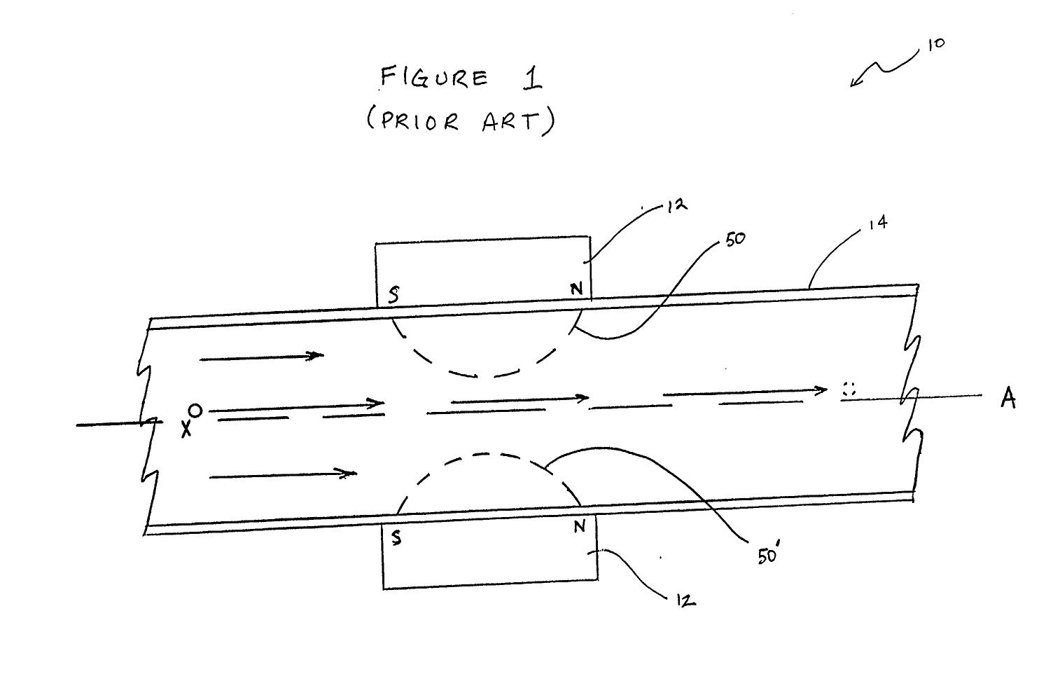

As shown in FIG. 3, the particular configuration of magnets 230-250 and pole structures 210-220 in each magnet apparatus 112, 112′ creates magnetic fluxes 150, 150′ which are longer and more narrow then the magnetic fluxes created by conventional apparatus (e.g. fluxes 50, 50′ of system 10, described above with reference to FIG. 1). In particular, the magnetic fluxes 150, 150′ created by the magnet apparatus 112, 112′ extend from each magnet apparatus substantially to a central axis of a pipe (e.g. axis A of pipe 114), and across to a magnet apparatus disposed on an opposite side of the pipe. By creating a magnetic fluxes 150, 150′ which stretch further into a pipe to which the magnetic apparatus 112, 112′ are attached, more particles traveling in the pipe can be affected by the fluxes, and consequently, a more efficient cleaning and treatment system can be achieved. Preferably, the magnetic fluxes 150, 150′ are made stronger than the magnetic charge on any particles which may be flowing in the liquid or gas contained in the pipe. Accordingly, when a charged particle encounters the stronger magnetic fluxes 150, 150′, it will go into a suspended state (as described above). When the particle(s) is in such a suspended state, it can be easily removed from the fluid or gas which is present in the pipe.

FIG. 3 shows a magnetic treatment system 100 which utilizes the magnetic apparatus 112 (or 112′) described above with reference to FIG. 2. FIG. 3 shows the magnetic fluxes 150, 150′ respectively created by magnet apparatus 112, 112′ according to the first exemplary embodiment of the present invention. Each of the fluxes 150, 150′ includes magnetic field lines which extend from a “south” pole of each respective magnet apparatus 112, 112′ to a “north” pole of a magnet apparatus disposed on an opposing side of the pipe 114. As can be seen, the magnetic flux 150 (indicated by dashed lines) of magnet apparatus 112 extends from a “south” pole 201 of the magnet apparatus, substantially to a central axis A of the pipe 114, and across to a “north” pole 202′ of magnet apparatus 112′. Similarly, the magnetic flux 150′ (indicated by dashed-dotted lines) of magnet apparatus 112′ extends from a “south” pole of the magnet apparatus 201′, substantially to a central axis A of the pipe 114, and across to a “north” pole 202 of magnet apparatus 112. Thus, by the combination of the magnetic fluxes 150, 150′, a magnetic field band 160 is created which extends across the entirety of the pipe 114, and consequently, substantially all particles which pass through the pipe (such as particle X) are affected by the magnetic field band.

In order to create such a magnetic field band 160 across the pipe 114, the magnets 230-250 must be selected to ensure a proper distribution of magnetic flux. For instance, the two magnets 235, 245 which are disposed with their poles orthogonal to the bottom wall 201 of the housing 200 should be of the same magnetic power, and the three magnets 230, 240, 250 which are disposed with their poles parallel to the bottom wall of the housing should be of the same magnetic power. Also, the two magnets 235, 245 should each be of a greater magnetic power than each of the three magnets 230, 240, 250. By selecting the magnets 230-250 in such a way, a long and narrow magnetic fluxes 150, 150′ which extend substantially to a central axis A of the pipe, and a resulting magnetic field band 160, are ensured.

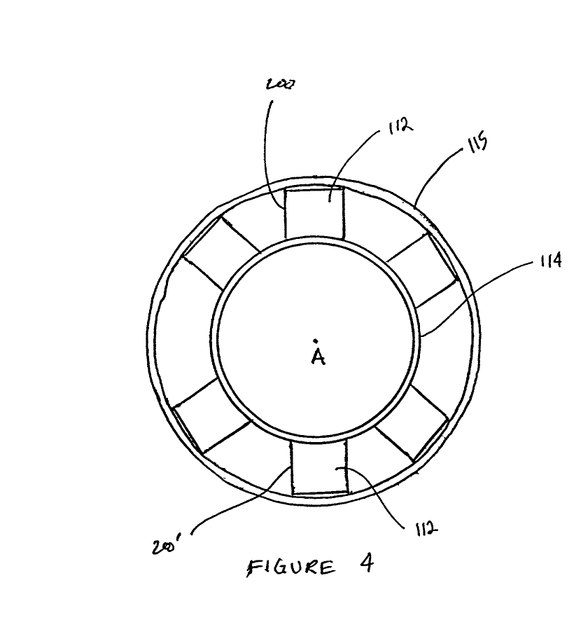

It should be noted that although only two magnetic apparatus 112, 112′ can be seen in FIG. 3, there are actually many such apparatus surrounding the pipe 114, each providing a separate magnetic flux (e.g. fluxes 150, 150′). FIG. 4 is a front view of the magnetic treatment system 100, showing six (6) magnetic apparatus (e.g. 112, 112′) attached to the pipe 114 by a retaining ring 115. The number of magnetic apparatus 112 shown in FIG. 4 is exemplary only, and one of ordinary skill in the art will realize that the number of magnetic apparatus 112 attached to the pipe 114 may be varied depending on (among other factors) the outer circumference of the pipe and the extent of treatment required.

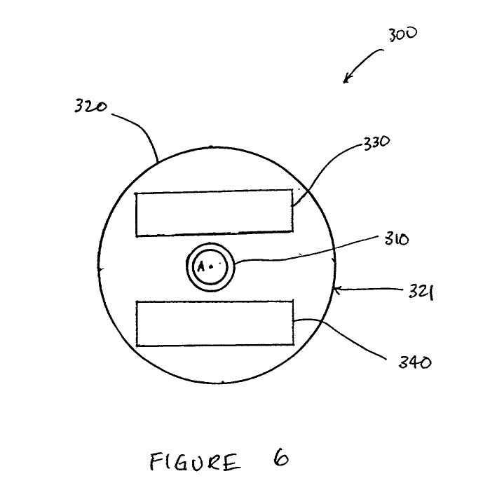

The magnetic apparatus 112 according to the first exemplary embodiment of the present invention may be used in a variety of different systems, most notable being fluid systems (e.g. water or chemical transmission networks), and combustion engine systems for automobiles. However, the magnetic apparatus 112 has application in any environment where the suspension of charged particles in a liquid or gas is required. Furthermore, it should be noted that the magnetic apparatus 112 according to the first exemplary embodiment of the present invention may be made in various sizes and with various magnetic field (flux) strengths, such that the apparatus may be adaptable to accommodate any conventional pipe size which may be encountered in the routine use of such a device. FIGS. 5 and 6 show a magnetic treatment system 300 according to a second exemplary embodiment of the present invention. The magnetic treatment system 300 is preferably utilized in a fuel treatment system. The magnetic treatment system includes a pipe 310 with a magnetic apparatus 320 disposed around the periphery thereof. The pipe 310 is preferably made of a non-magnetic material such as copper, aluminum or rubber. The magnetic apparatus 320 includes first 330 and second 340 magnet structures disposed in a housing 321. Although the housing 321 is shown as being substantially cylindrical in FIGS. 5 and 6, one of ordinary skill in the art will realize that the housing may be of any suitable shape (e.g. rectangular). The magnetic apparatus 320 further includes pole structures 350, 360 for directing the magnetic field created by the magnet structures 330, 340. Preferably, the pole structures 350, 360 are made of ferromagnetic metals, however they may be made of any ferromagnetic material. The magnetic apparatus 320 also includes areas 370 which may be filled with a non-magnetic (e.g. plastic) material, or may be left open.

Each of the first and second magnetic structures 330, 340 include a respective plurality of magnets 331-333, 341-343 disposed therein. The magnets 331-333 and 341-343 may be made as described above with reference to the first exemplary embodiment. The first magnetic structure 330 includes a first magnet 331 with its poles disposed orthogonal to the pipe 310, and with its “south” pole abutting the pipe. The first magnetic structure 330 also includes a second magnet 332 with its poles disposed parallel to the pipe 310, and with its “south” pole abutting the first magnet 331. Finally, the first magnetic structure 330 also includes a third magnet 333 with its poles disposed orthogonal to the pipe 310, and with its “north” pole abutting the pipe 310. The second magnetic structure 340 includes a first magnet 341 with its poles disposed orthogonal to the pipe 310, and with its “south” pole abutting the pipe. The first magnetic structure 340 also includes a second magnet 342 with its poles disposed parallel to the pipe 310, and with its “south” pole abutting the first magnet 341. Finally, the first magnetic structure 340 also includes a third magnet 343 with its poles disposed orthogonal to the pipe 310, and with its “north” pole abutting the pipe 310.

In operation, the magnetic treatment system 300 is inserted between two ends of a fuel line. Although not shown, the system preferably includes clamps on either side of the pipe 310 which allow attachment to the fuel line. Fuel which passes through the fuel line, and consequently the system 300, is then treated (as described above with reference to FIG. 3) by the magnetic apparatus 320. It should be noted that, unlike the magnetic treatment system 100 shown in FIG. 3, the pipe 310 preferably forms an integral part of the system. However, it is not necessary that the pipe 310 be an integral part of the system 300, the magnetic apparatus 320 may be formed so that it clamps around already existing pipes.

As with the first exemplary embodiment, the particular configuration of magnet structures 330, 340 and pole structures 350, 360 creates magnetic fluxes 380, 380′ which extend substantially to a central axis A of a pipe 310. By creating magnetic fluxes 380, 380′ which stretch further into the pipe 310, more particles traveling in the pipe can be affected by the fluxes, and consequently, a more efficient cleaning and treatment system can be achieved. Preferably, the magnetic fluxes (e.g. 380, 380′) through the pipe is made greater than the magnetic charge on any particles which may be flowing in the liquid or gas contained in the pipe. Accordingly, when a charged particle encounters the stronger magnetic fluxes, it will polarize and separate from the fluid as the particle moves through the pipe 310. The particle is, in effect, suspended in the pipe at the point where the magnetic flux exists.

It should be noted that each of the fluxes 380, 380′ include magnetic field lines which extend from a “south” pole of each respective magnet apparatus to a “north” pole of a magnet apparatus disposed on an opposing side of the pipe 310. As can be seen, the magnetic flux 380 (indicated by dashed lines) of magnet apparatus 330 extends from a “south” pole 335 of the magnet apparatus, substantially to a central axis A of the pipe 310, and across to a “north” pole 346 of magnet apparatus 340. Similarly, the magnetic flux 380′ (indicated by dashed-dotted lines) of magnet apparatus 340 extends from a “south” pole 345 of the magnet apparatus, substantially to a central axis A of the pipe 310, and across to a “north” pole 336 of magnet apparatus 330. Thus, by the combination of the magnetic fluxes 380, 380′, a magnetic field band 390 is created which extends across the entirety of the pipe 310, and consequently, substantially all particles which pass through the pipe are affected by the magnetic field band.

In order to create such a magnetic field band 390 across the pipe 310, the magnets 331-333 and 341-343 must be selected to ensure a proper distribution of magnetic flux. For instance, in the exemplary embodiment, the magnets 331-333 and 341-343 are all preferably of the same magnetic power. However, a desirable magnetic flux is also created when the two magnets 331, 333 and 341, 343 which are disposed with their poles orthogonal to the pipe 310 are of the same magnetic power, and the magnets 332 and 342 which are disposed with their poles parallel to the pipe 310 are of the same magnetic power, which is less than the magnetic power of the magnets 331, 333 and 341, 343. By selecting the magnets 331-333 and 341-343 in such a way, magnetic fluxes 380, 380′ which extend substantially to a central axis A of the pipe, and a resulting magnetic field band 390, are ensured.

It should be noted that the “heavy” metals (e.g. Iron (Fe), Zinc (Zn), Lead (Pb), etc.) present in the fuel and flowing in the pipe 310 also assist in the creation of an effective magnetic field band 390. They assist in concentrating the magnetic fluxes 380, 380′ produced by the magnet structures 330, 340 so that the magnetic fluxes extend to a central axis A of the pipe 310 and create the magnetic field band 390.

By removing the dissolved solids from the fuel, the fuel passes more easily through a carburetor or fuel injector. In the ignition chamber, the fuel can expand more (due to the absence of the dissolved solids), and therefore can ignite at a lower temperature. Accordingly, the burning of the fuel is more complete, and thus more power is extracted from the same amount of fuel. This, in turn, reduces emissions into the environment.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

What is claimed is:

1. A magnet apparatus comprising:
a housing with at least two side walls, and top and bottom walls connecting the side walls;
at least two first magnets disposed with their poles orthogonal to the bottom wall of the housing;
at least three second magnets disposed with their poles parallel to the bottom wall of the housing, one of said at least three second magnets being disposed between the at least two first magnets.

2. The magnet apparatus of claim 1, wherein the at least two first magnets and the at least three second magnets all abut the bottom wall of the housing.

3. The magnet apparatus of claim 1, further comprising:
a first pole structure extending along both sidewalls and the top wall of the housing.

4. The magnet apparatus of claim 3, further comprising:
a second pole structure extending between the at least two first magnets.

5. The magnet apparatus of claim 1, wherein a north pole of one of the at least two first magnets abuts the bottom wall of the housing, and a south pole of the other of the at least two first magnets abuts the bottom wall of the housing.

6. The magnet apparatus of claim 5, wherein south poles of two of the at least three second magnets abut the south pole of the other of the at least two first magnets, and a north pole of a third of the at least three second magnets abuts the north pole of the one of the at least two first magnets.

7. The magnet apparatus of claim 1, wherein the at least two first magnets are of the same magnetic strength and the at least three second magnets are of the same magnetic strength.

8. The magnet apparatus of claim 1, wherein the at least two first magnets and the at least three second magnets are made at least partially of a rare earth trivalent element.

9. The magnet apparatus of claim 1, wherein the at least two first magnets and the at least three second magnets are made at least partially of Neodymium.

10. The magnet apparatus of claim 1, wherein the at least two first magnets and the at least three second magnets are made at least partially of Neodymium, Boron and Iron.

11. A magnet apparatus comprising:
a first pole structure having first and second parallel sidewalls and a top wall connecting the pair of sidewalls;
at least one first magnet disposed with its poles parallel to the top wall, and so that its north pole abuts the first sidewall;
at least one second magnet disposed with its poles orthogonal to the top wall, and so that its south pole abuts a south pole of the at least one first magnet;
at least one third magnet disposed with its poles parallel to the top wall, and so that its south pole abuts the south pole of the at least one second magnet;
at least one fourth magnet disposed with its poles orthogonal to the top wall, and so that its north pole abuts a north pole of the at least one third magnet; and,
at least one fifth magnet disposed with its poles orthogonal to the top wall, and so that its south pole abuts the second sidewall.

12. The magnet apparatus of claim 11, wherein the first and second side walls and the top wall are made of ferromagnetic metals.

13. The magnet apparatus of claim 11, further comprising:
a housing, wherein the first pole structure, the at least one first magnet, the at least one second magnet, the at least one third magnet, the at least one fourth magnet, and the at least one fifth magnet are disposed within the housing.

14. The magnet apparatus of claim 11, further comprising:
a second pole structure coupling the north pole of the at least one second magnet to a south pole of the at least one fourth magnet.

15. The magnet apparatus of claim 14, wherein the first and second side walls, the top wall, and the second pole structure are made of ferromagnetic metal.

16. The magnet apparatus of claim 14, further comprising:
a housing, wherein the first pole structure, the second pole structure, the at least one first magnet, the at least one second magnet, the at least one third magnet, the at least one fourth magnet, and the at least one fifth magnet are disposed within the housing.

17. A magnetic apparatus comprising:
a housing with a recess formed therein for receiving a pipe;
a first magnet structure disposed in the housing, said first magnet structure comprising a first magnet with its poles disposed orthogonal to the recess, a second magnet with its poles disposed parallel to the recess, and a third magnet with its poles disposed orthogonal to the recess.

18. The magnetic apparatus of claim 17, further comprising:
a second magnet structure disposed in the housing, said second magnet structure comprising a first magnet with its poles disposed orthogonal to the recess, a second magnet with its poles disposed parallel to the recess, and a third magnet with its poles disposed orthogonal to the recess.

19. The magnetic apparatus of claim 18, further comprising:
a pipe disposed in the recess, wherein the first and second magnetic structures are disposed on opposite sides of the pipe.

20. The magnetic apparatus of claim 18, wherein the first magnet of the first magnet structure has its south pole abutting the recess, the second magnet of the first magnet structure has its south pole abutting the first magnet of the first magnet structure, and the third magnet of the first magnet structure has its north pole abutting the recess.

21. The magnetic apparatus of claim 20, wherein the first magnet of the second magnet structure has its south pole abutting the recess, the second magnet of the second magnet structure has its south pole abutting the first magnet of the second magnet structure, and the third magnet of the second magnet structure has its north pole abutting the recess.

22. The magnetic apparatus of claim 18, wherein the first, second and third magnets of the first magnet structure and the first, second and third magnets of the second magnet structure are made at least partially of a rare earth trivalent element.

23. The magnet apparatus of claim 18, wherein the first, second and third magnets of the first magnet structure and the first, second and third magnets of the second magnet structure are made at least partially of Neodymium.

24. The magnet apparatus of claim 18, wherein the first, second and third magnets of the first magnet structure and the first, second and third magnets of the second magnet structure are made at least partially of Neodymium, Boron and Iron.

25. The magnetic apparatus of claim 18, wherein the first, second and third magnets of the first magnet structure and the first, second and third magnets of the second magnet structure are all of a first magnetic power.

26. The magnetic apparatus of claim 18, wherein the first and third magnets of the first magnet structure and the first and third magnets of the second magnet structure are of a first magnetic power, and the second magnet of the first magnet structure and the second magnet of the second magnet structure are of a second magnetic power, said first magnetic power being greater than said second magnetic power.

27. A magnetic treatment system comprising:
a pipe for carrying fluid or gas; and,
a magnet apparatus comprising a housing with at least two side walls, and top and bottom walls connecting the side walls; at least two first magnets disposed with their poles orthogonal to the bottom wall of the housing; and at least three second magnets disposed with their poles parallel to the bottom wall of the housing,,wherein one of said at least three second magnets being disposed between the at least two first magnets.

28. The magnetic treatment system of claim 27, wherein a magnetic flux generated by the magnet apparatus extends substantially to central axis of the pipe.

29. The magnetic treatment system of claim 27, wherein the at least two first magnets are of the same magnetic strength and the at least three second magnets are of the same magnetic strength.

30. A magnetic treatment system comprising:
a pipe for carrying fluid or gas; and,
a magnet apparatus comprising a first pole structure having first and second parallel sidewalls and a top wall connecting the pair of sidewalls; at least one first magnet disposed parallel to the top wall, and so that its north pole abuts the first sidewall; at least one second magnet disposed perpendicular to the top wall, and so that its south pole abuts a south pole of the at least one first magnet; at least one third magnet disposed parallel to the top wall, and so that its south pole abuts the south pole of the at least one second magnet; at least one fourth magnet disposed perpendicular to the top wall, and so that its north pole abuts a north pole of the at least one third magnet; and, at least one fifth magnet disposed parallel to the top wall, and so that its south pole abuts the second sidewall.

31. The magnetic treatment system of claim 30, wherein the first and second side walls and the top wall of the magnet apparatus are made of ferromagnetic metal.

32. The magnetic treatment system of claim 30, further comprising:
a second pole structure coupling the north pole of the at least one second magnet to a south pole of the at least one fourth magnet.

33. The magnetic treatment system of claim 32, wherein the first and second side walls, the top wall, and the second pole structure of the magnet apparatus are made of ferromagnetic metal.

34. The magnetic treatment system of claim 30, wherein a magnetic flux generated by the magnet apparatus extends substantially to central axis of the pipe.

35. A method removing impurities from a liquid or gas comprising the steps of:
disposing at least one magnet apparatus in an abutting relationship with a pipe carrying the liquid or gas; and
adjusting a magnetic flux of the at least one magnet apparatus so that the flux substantially extends to a central axis of the pipe.

36. The method of claim 35, wherein the step of adjusting the magnetic flux comprises altering the orientation of a plurality of magnets disposed within the at least one magnet apparatus.

37. The method of claim 35, wherein the step of disposing at least one magnet apparatus comprises disposing at least two first magnet apparatus and at least three second magnet apparatus, wherein poles of the at least two first magnet apparatus are arranged orthogonal to a main axis of the pipe and poles of the at least three second magnet apparatus are arranged parallel to the main axis of the pipe.

38. The method of claim 35, wherein the step of disposing at least one magnet apparatus comprises disposing at least two first magnet apparatus and at least one second magnet apparatus on each side of the pipe, wherein poles of the at least two first magnet apparatus are arranged orthogonal to a main axis of the pipe and poles of the at least one second magnet apparatus are arranged parallel to the main axis of the pipe.
